(19) United States
(12) Patent Application Publication
(10) Pub. No.: US 2026/0093561 A1
(43) Pub. Date: Apr. 2, 2026

(54) ALERT FLOOD CONTROL

(71) Applicant: WELLS FARGO BANK, N.A., San Francisco, CA (US)

(72) Inventors: Shameem AHAMED, Marlboro, NJ (US); David Doyle DICKINSON, Denver, CO (US); David GRIMM, Concord, NC (US); Mohan Gopal KANALA, Hyderabad (IN)

(21) Appl. No.: 18/901,263

(22) Filed: Sep. 30, 2024

(51) Int. Cl. G06F 9/54

(52) U.S. Cl. CPC G06F 9/542

(57) ABSTRACT

A computer system for controlling alert floods includes one or more processors and non-transitory computer-readable storage media encoding instructions. The instructions direct the computer system to provide an interface for receiving alerts and determine an alert flood condition based on a number of alerts received at the interface over time and an alert threshold. The alert threshold includes a number of alerts and a duration of an alert window. The instructions further direct the computer system to direct received alerts to a first queue outside of the alert flood condition and direct received alerts to a second queue during the alert flood condition. Enrichment information can be added to alerts in the second queue, and the alerts in the second queue can be processed according to the enrichment information to prioritize the alerts, remove duplicate alerts, or generate tickets.

### BACKGROUND

Alerts can be provided in network infrastructure to provide notification regarding any unforeseen scenarios in applications, networks, databases, or other infrastructure. High volumes of alerts can create floods that occupy significant computing resources and delay processing of other events. Some alerts can be duplicative, non-actionable, of limited impact or importance, or otherwise be ignored.

### SUMMARY

This disclosure relates to the control of alert floods.

In an example embodiment, a computer system for controlling alert floods includes one or more processors. The computer system further includes non-transitory computer-readable storage media encoding instructions which, when executed by the one or more processors, causes the computer system to provide an interface configured to receive alerts and determine an alert flood condition based on a number of alerts received at the interface over time and an alert threshold. The alert threshold includes a number of alerts and a duration of an alert window. The instructions further cause the computer system to direct received alerts to a first queue outside of the alert flood condition and direct received alerts to a second queue during the alert flood condition.

In an example embodiment, a method for controlling alert floods includes receiving alerts at an interface and determining, using a processor, an alert flood condition based on a number of alerts received at the interface over time and an alert threshold. The alert threshold includes a number of alerts and a duration of an alert window. The method further includes directing received alerts to a first queue when outside the alert flood condition and directing received alerts to a second queue when in the alert flood condition.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system for providing flood control for alerts.

FIG. 2 shows example logical components of the system of FIG. 1.

FIG. 3 shows example physical components of a server device of FIG. 1.

FIG. 4 shows an example method as performed by the system of FIG. 1.

### DETAILED DESCRIPTION

This disclosure relates to the control of alert floods.

Generally, alerts are provided to automated and human resources to coordinate the handling of issues occurring in various applications, networks, databases, or other information infrastructure. Some alert sources can generate significant numbers of alerts within a short span of time. When the volume of alerts in a short span of time becomes excessive, an alert flood can occur. The alert flood can be computationally intensive and can delay handling of other network or system issues and/or reduce the efficiency of network resources and/or personnel.

There can be various advantages associated with the technologies described herein. Determining when alert floods are occurring and directing the alerts to an alert flood queue during such floods can ensure system resources are allocated efficiently to addressing the various alerts. Additionally, directing alerts to the alert flood queue during floods can reduce delays for addressing other events occurring in the network. Enriching the alerts in the alert flood queue with additional data can improve the prioritization of alerts and allow the alert floods to be handled more efficiently. Use of the alert flood queue and the enrichment of the alerts can allow the alerts to be addressed with appropriate priority, as opposed to being completely suppressed.

Accordingly, the response to alert floods in the system or network can be improved, thereby improving the robustness and uptime of the system or network. The improved response to alert floods can avoid processing delays or network resources becoming overwhelmed. Sending alerts of a determined alert flood to an alert flood queue can ensure that critical issues in a system or network are addressed with suitable priority, without loss or suppression of potentially relevant alerts. Other advantages are possible.

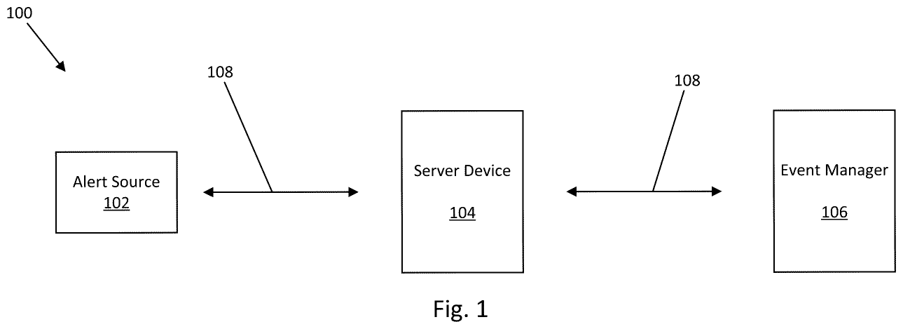

FIG. 1 shows an example system 100 for providing flood control for alerts. System 100 includes an alert source 102, a server device 104, and an event manager 106. Each of the alert source 102, server device 104, and event manager 106 may be implemented as one or more computing devices with at least one processor and at least one memory. Example computing devices include a mobile computer, a desktop computer, a server computer, or other computing device or devices such as a server farm or cloud computing used to generate or receive data. The alert source 102 and the event manager 106 can communicate with the server device 104 through a network 108 to accomplish the functionality described herein.

Alert source 102 can include one or more sources of alerts regarding errors, faults, unforeseen scenarios, or the like occurring in one or more applications, networks, databases, or other technological infrastructure. The alert source 102 is configured to communicate with the server device 104 by way of network 108, such that alerts are received at an interface of the server device 104. Alert source 102 can be, for example, one or more information technology (IT) infrastructure monitoring tools, for example artificial intelligence for IT operations (AIOps) systems or components thereof. In an embodiment, the alert source 102 is an AIOps alert pipeline.

Server device 104 is configured to receive alerts from one or more alert sources 102 and to determine when an alert flood condition exists. Server device 104 can receive the alerts from alert source(s) 102 through any suitable interface, for example an application program interface (API) such as an API microservice configured to receive alert posts. In an embodiment, the API can be a representational state transfer (REST) API. The alert posts received at the interface can be, for example, RESTful alert posts.

Server device 104 is configured to determine when the alert flood condition exists, for example based on a sliding window. The sliding window can include a threshold for a number of alerts, and a size of the window in time. The alert flood condition can be determined to exist when the number of alerts within a window of time exceeds a maximum number of alerts for said window of time. The window of time can be selected based on the environment where alert flood control is desired. For example, the window of time can be at or about one minute. The window of time can be based, for example, on a user selection. Server device 104 is configured to assign the alerts to queues based on whether the alert flood condition has been determined to exist. The queues can be implemented in, for example, Apache Kafka.

The alerts can be directed to a first queue when outside of an alert flood condition, and to a second queue during the alert flood condition. Alerts from the queues can be provided to event manager 106 according to the queues. In an embodiment, server device 104 provides alerts from the first queue to the event manager 106 according to a first in-first out (FIFO) order. In an embodiment, server device 104 is further configured to associate enrichment information with alerts in the second queue. The enrichment information can be used to correlate alerts, remove duplicate alerts, prioritize alerts, provide notification of alerts, automate handling of the alerts, or the like.

Event manager 106 is configured to perform notification and ticketing regarding the alerts received from alert source 102 and processed at server device 104. Event manager 106 can be, for example, an IT ticketing system, a component of an AIOps system, or the like. In an embodiment, the server device 104 includes the event manager 106. In an embodiment, the event manager is a separate computing environment in communication with the server device 104. Event manager 106 can perform automated response to alerts, and/or notifications to automated or human responders such as AIOps system resources, IT personnel, or the like. Event manager 106 can prepare tickets and dispatch the tickets to suitable IT personnel.

The network 108 provides a wired and/or wireless connection between the alert source 102, the event manager 106, and the server device 104. In some examples, the network 108 can be a local area network, a wide area network, the internet, or a mixture thereof. Many different communication protocols can be used. Although only three devices are shown, the system 100 can accommodate hundreds, thousands, or more of computing devices.

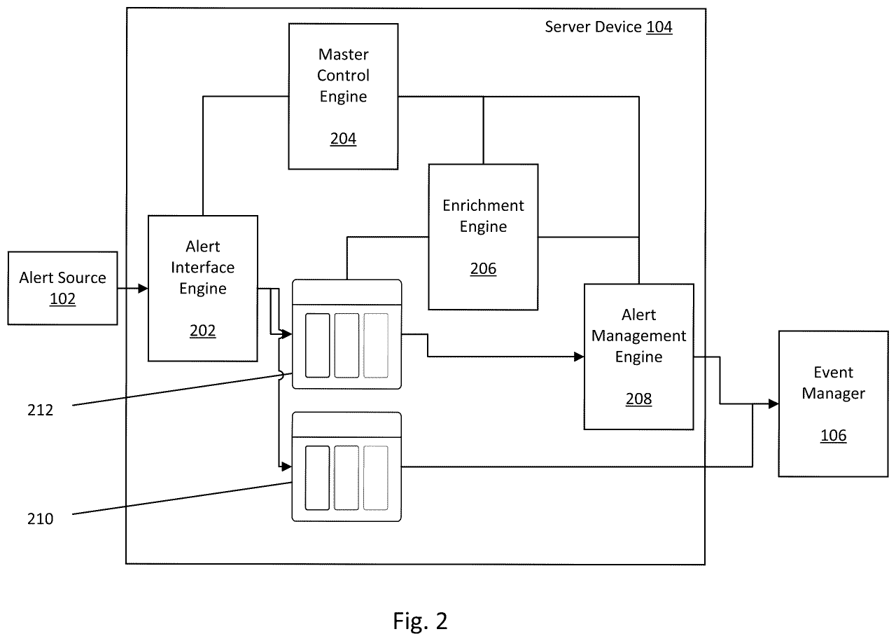

FIG. 2 shows example logical components of the system of FIG. 1. The server device 104 includes alert interface engine 202, master control engine 204, enrichment engine 206, and alert management engine 208. The server device 104 further includes a first alert queue 210 and a second alert queue 212. In other examples, more or fewer engines providing different functionality can be used.

Alert interface engine 202 is configured to receive alerts from one or more alert sources 102. The alert interface engine 202 can include, for example, an API. In an embodiment, the API can be a microservice. In an embodiment, the API is a RESTful API. Alert interface engine 202 can be configured to track the number of alerts being received over time from one or more alert sources 102. In an embodiment, alert interface engine 202 is configured to separately track the number of alerts being received over time from each of a plurality of alert sources 102.

Alert interface engine 202 can optionally include a load balancer. The load balancer can receive raw alerts. In an embodiment, the load balancer can detect whether alert traffic is abnormal, for example being associated with a directed denial-of-service attack (DDOS) and block such abnormal alerts. Alerts that are not such abnormal alerts can be directed by the load balancer to a raw alert topic. In an embodiment, the alerts can be directed to the raw alert topic as the alerts are received. Alert interface engine 202 can be configured to determine whether an alert flood condition is occurring for at least one of the one or more alert sources 102.

The alert interface engine 202 can be configured to determine the occurrence of the alert flood condition by comparing the number of alerts received over time to a sliding window. The sliding window can include a window size in time and a threshold for the number of alerts. The alert flood condition can be determined to exist when the number of alerts received within the window in time exceeds the threshold. In an embodiment, the alert interface engine 202 can apply the sliding window to each of a plurality of alert sources 102 or groupings thereof.

In an embodiment, the sliding window is applied by alert interface engine 202 to the total alerts received from all alert sources 102. When an alert flood condition is determined to occur at alert interface engine 202, the alert interface engine 202 can send a message to master control engine 204 indicating the alert flood. The alert interface engine 202 can determine a message identifier of the first alert in the alert flood. The alert interface engine 202 can direct received alerts to the first alert queue 210 or the second alert queue 212 based on direction from the master control engine 204. For example, when an alert flood condition is determined to be occurring, the master control engine 204 can direct the alert interface engine 202 to direct the first alert of the alert flood and all subsequently received alerts to the second alert queue 212.

The alert interface engine 202 can further determine the end of the alert flood condition. The end of the alert flood condition can be determined using the sliding window, determining that the alert flood has ended when the number of alerts within the time window has fallen below a threshold value. In an embodiment, the time window for the sliding window used to determine an end to the alert flood condition can be the same size as the time window used to determine the alert flood condition. When an end of the alert flood has been determined, the alert interface engine 202 can send a message to master control engine 204 indicating that the alert flood has ended.

Master control engine 204 can be configured to receive the determination of the alert flood condition from alert interface engine 202, and to direct the alert interface engine 202 to assign alerts to the second alert queue 212 when an alert flood condition has been determined. In an embodiment, when master control engine 204 directs the alert interface engine 202 to send alerts to the second alert queue 212, the alert interface engine 202 can provide an acknowledgement of the instructions to send the alerts to the second alert queue 212. When the alert flood condition has been determined, master control engine 204 can further direct enrichment engine 206 and/or alert management engine 208 to begin processing alerts in the second alert queue 212. When the master control engine 204 receives a message indicating the end of the alert flood, the master control engine 204 can direct the alert interface engine 202 to direct the alerts to be assigned to the first alert queue 210.

The alert interface engine 202 can provide a message to master control engine 204 acknowledging the instructions to assign alerts to the first alert queue 210. When the master control engine 204 receives a message indicating the end of the alert flood, the master control engine 204 can send the enrichment engine 206 a message identifier for the final message of the flood. When the enrichment engine 206 finishes enriching the alerts from the alert flood in the second alert queue 212, the enrichment engine can send a message to the master control engine 204 indicating the completion of enrichment of the alerts of the flood. When the master control engine receives the indication that enrichment engine 206 has completed the enrichment of the alerts, the master control engine 204 can send a message to the alert management engine 208 indicating closure of the alert flood.

Enrichment engine 206 is configured to add enrichment information to at least some of the alerts in the second alert queue 212. The enrichment information is additional information relevant to the notification, automation, correlation, duplicate detection, or other such processes for the handling of alerts. The enrichment information can be determined at least in part based on features of the alert or the content thereof, and/or be based on information from sources external to the alert. The enrichment information can include information allowing the programmatic identification of messages impacted by the alert flood. The enrichment information can include information indicative of the start of the alert flood and the management thereof.

In an embodiment, the enrichment information can include a unique identifier of an initial alert of the alert flood, and a status identifier for the alert flood being an active condition. In an embodiment, enrichment engine 206 receives an alert from the second alert queue 212, adds the enrichment information, and places the enriched alert into a queue or topic, such as an Apache Kafka topic, configured to receive the enriched alert. In an embodiment, the enrichment information is added to the alert while the alert remains in the second alert queue 212.

Alert management engine 208 is configured to process alerts in the second alert queue 212 based on enrichment information added thereto. The alert management engine can correlate alerts, determine the existence of duplicate alerts, remove duplicate alerts, prioritize alerts, automate alerts, or the like. Alert management engine 208 can determine, based on removal of duplicates, prioritization, and the like, alerts from the second alert queue 212 to be provided to event manager 106 for ticketing and notification.

First alert queue 210 can receive alerts from the alert interface engine 202 when it is determined that the system is not in an alert flood condition. First alert queue 210 can be provided, for example, as an Apache Kafka topic or queue. First alert queue 210 can store the alerts and record when the alerts were received. The alerts from the first alert queue 210 can be provided to the event manager 106, for example according to a first-in, first out (FIFO) process. In an embodiment, all alerts from the first alert queue are provided to the event manager 106 according to the FIFO process.

Second alert queue 212 can receive alerts from the alert interface engine 202 when it is determined that the system 100 is in an alert flood condition. Second alert queue 212 can be provided, for example, as an Apache Kafka topic or queue. The second alert queue 212 can store the received alerts. In an embodiment, following the addition of enrichment information to alerts by the enrichment engine 206, the second alert queue 212 can store the enrichment information associated with each of said alerts. Alerts in the second alert queue 212 can be provided to the alert management engine 208 following addition of the enrichment information.

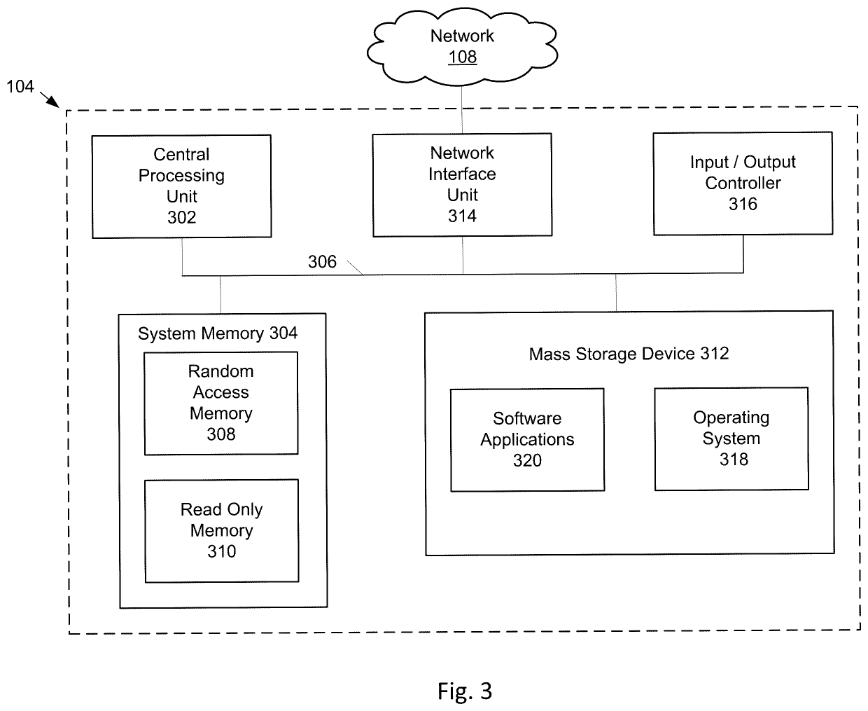

FIG. 3 shows example physical components of the server device of FIG. 1. As illustrated in FIG. 3, the server device 104 can include at least one central processing unit (“CPU”) 302, a system memory 304, and a system bus 306 that couples the system memory 304 to the CPU 302. The system memory 304 includes a random-access memory (“RAM”) 308 and a read-only memory (“ROM”) 310. A basic input/output system containing the basic routines that help transfer information between elements within the server device 112, such as during startup, is stored in the ROM 310. The server device 104 further includes a mass storage device 312. The mass storage device 312 can store software instructions and data. A central processing unit, system memory, and mass storage device similar to that shown can also be included in the other computing devices disclosed herein.

The mass storage device 312 is connected to the CPU 302 through a mass storage controller (not shown) connected to the system bus 306. The mass storage device 312 and its associated computer-readable data storage media provide non-volatile, non-transitory storage for the server device 104. Although the description of computer-readable data storage media contained herein refers to a mass storage device, such as a hard disk or solid-state disk, it should be appreciated by those skilled in the art that computer-readable data storage media can be any available non-transitory, physical device, or article of manufacture from which the central display station can read data and/or instructions. Computer-readable data storage media include volatile and non-volatile, removable and non-removable media implemented in any method or technology for storage of information such as computer-readable software instructions, data structures, program modules, or other data. Example types of computer-readable data storage media include, but are not limited to, RAM, ROM, EPROM, EEPROM, flash memory or other solid-state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the server device 104.

According to various embodiments of the invention, the server device 104 may operate in a networked environment using logical connections to remote network devices through network 108, such as a wireless network, the Internet, or another type of network. The server device 104 may connect to network 108 through a network interface unit 314 connected to the system bus 306. It should be appreciated that the network interface unit 314 may also be utilized to connect to other types of networks and remote computing systems. The server device 104 also includes an input/output controller 316 for receiving and processing input from a number of other devices, for example a touch user interface display screen or another type of input device. Similarly, the input/output controller 316 may provide output to a touch user interface display screen or other output devices.

As mentioned above, the mass storage device 312 and the RAM 308 of the server device 104 can store software instructions and data. The software instructions include an operating system 318 suitable for controlling the operation of the server device 104. The mass storage device 312 and/or the RAM 308 also store software instructions and applications 320, that when executed by the CPU 302, cause the server device 104 to provide the functionality of the server device 104 discussed in this document.

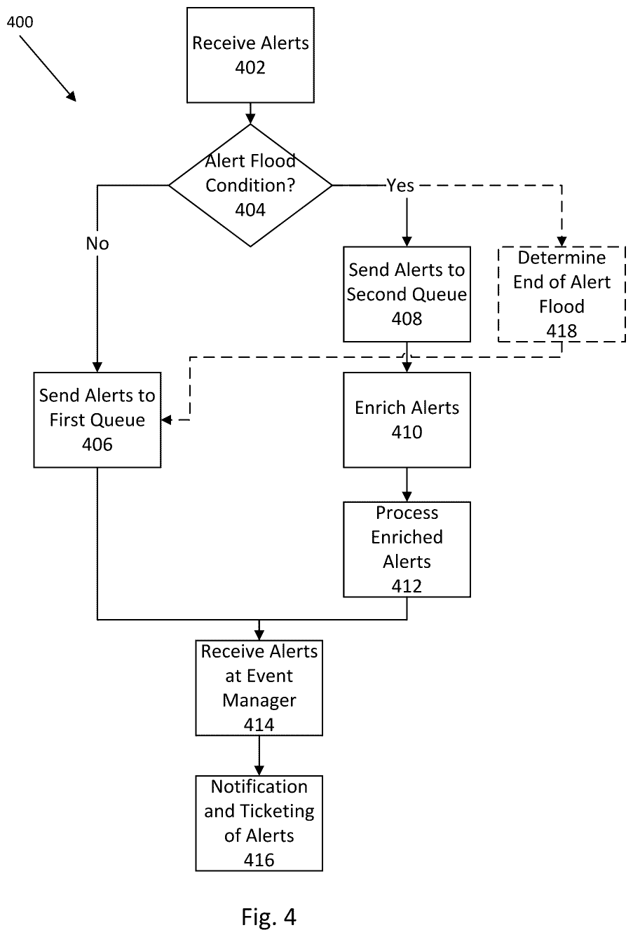

FIG. 4 shows a method 400 according to an embodiment. Method 400 includes receiving a plurality of alerts 402, determining occurrence of an alert flood condition 404, sending alerts to a first queue when outside the alert flood condition 406, and sending alerts to a second queue when in the alert flood condition 408. Method 400 can optionally further include adding enrichment information to alerts in the second queue at 410. Method 400 can optionally further include processing alerts based on the enrichment information at 412. Method 400 can further include receiving the alerts at an event manager 414 and notification and ticketing of the alerts at the event manager 416.

A plurality of alerts is received at 402. The alerts are received by an interface, for example alert interface engine 202 as described above and shown in FIG. 2. The alerts can include alerts regarding errors, faults, unforeseen scenarios, or the like occurring in one or more applications, networks, databases, or other technological infrastructure. The alerts can be, for example, RESTful alerts. Each of the alerts received at 402 can have an identifier. Alerts received at 402 can be from one or more alert sources. When the alerts are received at 402, the number of alerts received can be determined. The number of alerts can be determined in total, and/or for specific alert sources or groups thereof. The number of alerts received at 402 can be tracked over time. In an embodiment, the alerts received at 402 include a time stamp. In an embodiment, the timing of receipt of alerts at 402 can be logged, for example at the interface receiving the alerts.

Occurrence of an alert flood condition is determined at 404. The occurrence of the alert flood condition can be determined using a sliding window including a threshold value for a number of alerts and a size of a time window. When the number of alerts received within the time window exceeds the threshold value, the alert flood condition is determined. When the number of alerts received within the time window does not exceed the threshold value, no alert flood condition is determined to be occurring. The occurrence of the alert flood condition can be determined at 404 based on alerts from all sources, or on alerts from specific alert sources or groups thereof.

In an embodiment, each alert source or group of alert sources can have a respective sliding window used for the determination of the alert flood condition for said alert source or group. When an alert flood condition is determined to be occurring at 404, an identifier for the first alert of the alert flood (for example, the oldest message within the time window at the determination of the alert flood condition) can be determined, and the identifier can be provided to the interface or any other component directing the flows of alerts to queues.

Alerts are sent to a first queue at 406. The sending of alerts to the first queue at 406 can be performed when it is determined at 404 that an alert flood condition is not currently occurring. The first queue can receive the alerts sent at 406 and store the alerts for processing according to standard protocols, for example processing the alerts according to a first in-first out (FIFO) process. The alerts can be provided from the first queue to an event manager in the order the alerts were received at the first queue. The alerts provided from the first queue can be received at the event manager 414 and notification and ticketing of the alerts can be performed by the event manager at 416. In an embodiment, once an alert flood condition has ended, alerts having message identifiers following the message identifier of the alert identified as the final alert of the flood can be sent to the first queue at 406.

Alerts are sent to a second queue at 408. The alerts are sent to the second queue at 408 when it is determined at 404 that an alert flood condition is occurring. The alerts sent to the second queue at 408 can be alerts identified as being part of the alert flood, for example coming from particular sources that are experiencing the alert flood condition. In an embodiment, alerts can be sent to the second queue at 408 when said events have message identifiers that follow a message identifier of a first alert of the alert flood condition, and when a message marking an end of the alert flood condition has not been identified.

Enrichment information can be added to the alerts in the second queue at 410. The enrichment information can be added to the alerts by an enrichment engine, such as enrichment engine 206 described above and shown in FIG. 2. The enrichment information can include any suitable information regarding notification, automation, correlation, or prioritization of the alerts in the second queue. The enrichment information can be based on features included in the alert, external information, or combinations thereof. The enrichment information can be added at 410 to alerts and the alerts can remain in the second queue, or the alerts can be moved to another queue following addition of the enrichment information at 410.

Alerts from the second queue having enrichment information added at 410 can be processed according to the enrichment information at 412. Processing according to the enrichment information 412 can include utilizing the enrichment information to correlate alerts in the second queue and remove duplicate alerts. Processing according to the enrichment information at 412 can include prioritizing alerts based on the corresponding enrichment information. Based on the processing of the alerts at 412, at least some alerts in the second queue can be provided to an event manager for automation, ticketing, or the like.

The alerts can be received at the event manager at 414. The event manager can receive the alerts from the first queue according to the FIFO processing of alerts at the first queue. The event manager can receive alerts from the second queue based on the processing according to the enrichment information at 412. The event manager can perform notification and ticketing of the alerts at 416. The event manager can provide the alerts to the proper automated or human resources (for example, by tickets, notifications, or the like) such that underlying incidents resulting in the alerts can be investigated or resolved.

An end of the alert flood can be determined at 418 The end of the alert flood can be determined at 418 based on a sliding window including a threshold value and a window size in time. When the number of alerts received within the window are below the threshold value. In an embodiment, the threshold value and window size are the same as the threshold value and window size used to determine the alert flood condition at 404. When the end of the alert flood has been determined at 418, the flow of alerts to the second queue can end, and subsequent alerts can be directed to the first queue. When the end of the alert flood is determined at 418, an identifier of a final alert of the alert flood, for example the most recent alert within the sliding window where the number of alerts is below the threshold value, can be determined. The identifier of the final message of the flood can be used to determine when messages should resume being directed to the first queue.

Although various embodiments are described herein, those of ordinary skill in the art will understand that many modifications may be made thereto within the scope of the present disclosure. Accordingly, it is not intended that the scope of the disclosure in any way be limited by the examples provided.

What is claimed is:

1. A computer system for controlling alert floods, comprising:
one or more processors; and
non-transitory computer-readable storage media encoding instructions which, when executed by the one or more processors, causes the computer system to:
provide an interface configured to receive alerts;
determine an alert flood condition based on a number of alerts received at the interface over time and an alert threshold, the alert threshold including a number of alerts and a duration of an alert window;
direct received alerts to a first queue outside of the alert flood condition; and
direct received alerts to a second queue during the alert flood condition.

2. The computer system of claim 1, wherein the non-transitory computer-readable storage media encodes further instructions which, when executed by the one or more processors, cause the computer system to add enrichment information to the received alerts in the second queue.

3. The computer system of claim 2, wherein the non-transitory computer-readable storage media encodes further instructions which, when executed by the one or more processors, cause the computer system to process the alerts in the second queue based on the enrichment information.

4. The computer system of claim 2, wherein the enrichment information correlates alerts in the second queue.

5. The computer system of claim 1, wherein the non-transitory computer-readable storage media encodes further instructions which, when executed by the one or more processors, cause the computer system to identify a first message of the alert flood condition.

6. The computer system of claim 1, wherein the non-transitory computer-readable storage media encodes further instructions which, when executed by the one or more processors, cause the computer system to determine an end of the alert flood condition.

7. The computer system of claim 6, wherein the non-transitory computer-readable storage media encodes further instructions which, when executed by the one or more processors, cause the computer system to identify a final message of the alert flood condition.

8. The computer system of claim 1, wherein the interface is configured to receive alerts from each of a plurality of alert sources.

9. The computer system of claim 8, wherein the instructions, when executed by the one or more processors, cause the computer system to determine the alert flood condition for one of the plurality of alert sources based on a number of alerts received at the interface over time from said one of the plurality of alert sources and the alert threshold.

10. The computer system of claim 9, wherein when the alert flood condition is determined for one of the plurality of alert sources, alerts from another of the plurality of alert sources are directed to the first queue.

11. A method for controlling alert floods, comprising:
receiving alerts at an interface;
determining, using a processor, an alert flood condition based on a number of alerts received at the interface over time and an alert threshold, the alert threshold including a number of alerts and a duration of an alert window;
directing received alerts to a first queue when outside the alert flood condition; and
directing received alerts to a second queue when in the alert flood condition.

12. The method of claim 11, further comprising adding enrichment information to alerts in the second queue using the processor.

13. The method of claim 12, further comprising processing the alerts in the second queue based on the enrichment information.

14. The method of claim 13, wherein processing the alerts in the second queue includes detecting duplicate alerts based on the enrichment information and removing said duplicate alerts.

15. The method of claim 11, further comprising identifying a first message of the alert flood condition.

16. The method of claim 11, further comprising determining, using the processor, an end of the alert flood condition.

17. The method of claim 16, further comprising identifying a final message of the alert flood condition.

18. The method of claim 11, wherein the interface is configured to receive alerts from each of a plurality of alert sources.

19. The method of claim 18, wherein the alert flood condition is determined for one of the plurality of alert sources based on a number of alerts received at the interface over time from said one of the plurality of alert sources and the alert threshold.

20. The method of claim 19, wherein when the alert flood condition is determined for one of the plurality of alert sources, alerts from another of the plurality of alert sources are directed to the first queue.
